(19) United States
(12) Patent Application Publication
(10) Pub. No.: US 2013/0003898 A1
(43) Pub. Date: Jan. 3, 2013

(54) Digital Broadcast Reception Processing Apparatus

(75) Inventors: Masaki Saga, Osaka (JP); Yuji Fujiwara, Kanagawa (JP); Kenji Ito, Osaka (JP); Masashi Eguchi, Kyoto (JP)

(73) Assignee: PANASONIC CORPORATION, Kadoma-shi, Osaka (JP)

(21) Appl. No.: 13/583,641

(22) PCT Filed: Mar. 23, 2011
(86) PCT No.: PCT/JP2011/001695

§ 371 Date: Sep. 10, 2012

(30) Foreign Application Priority Data
Mar. 23, 2010 (JP) 2010-066039

(51) Int. Cl. H04B 7/08

(52) U.S. Cl. 375/340

(57) ABSTRACT

A digital broadcast reception processing apparatus including: a plurality of antennas; a plurality of demodulation sections; a demodulation apportioning section configured to divide a plurality of demodulated signals into, and output the divided signals of, Process One unit and Process Two unit; a carrier-combining section configured to combine carrier in the demodulated signals of the Process One unit, and output the carrier-combined demodulated signals; a main processing section configured to process the carrier-combined demodulated signals; a sub-processing section configured to process the demodulated signal of the Process Two unit; and a sub-processing demodulation selecting section configured to control the division of the demodulation apportioning section. The sub-processing demodulation selecting section decides, and instructs the demodulation apportioning section as to, demodulated signals to be divided into the Process One unit and the Process Two unit on the basis of a plurality of signal intensities obtained from the plurality of demodulation sections.

### TECHNICAL FIELD

The present invention relates to diversity-reception-type digital broadcast reception processing apparatuses, and more specifically, relates to digital broadcast reception processing apparatuses that have a plurality of demodulation sections and can divide the demodulation sections so as to use a predetermined number of demodulation sections, among the plurality of demodulation sections, for main processing and so as to use the remaining demodulation sections for sub-processing, when simultaneously performing two processes.

### BACKGROUND ART

Among conventional broadcast receiving apparatuses, some adopt a diversity reception method so as to be suited to mobile reception, wherein combining received signals yields stable and enhanced reception levels. Consequently, means for removing signals that are likely to generate noise, and for preventing antenna changeover from occurring frequently have been taken (e.g., see Patent Literature 1).

In addition, also in existence are broadcast receiving apparatuses having a plurality of demodulation sections and designed to enable image reception (video display) to be implemented simultaneously with a signal-reception evaluation process, to realize continuous reception by switching the broadcast stations received.

Here, for a conventional broadcast receiving apparatus to receive digital broadcasts, as long as the received digital broadcast signals can be decoded, sought-after information is decoded and the video, sound, and data are presented to the user. However, even without decoding a digital broadcast signal, it is possible to determine whether the signal is receivable, merely by obtaining the signal intensity. That is, the signal intensity being weak allows it to be determined that, because the decoding for presenting video and sound to the user cannot be sufficiently performed, signal reception is impossible.

In addition, in digital broadcasting, the information identifying a broadcast station is transmitted on a layer at which reception is easily performed. Conversely, video and sound require a large volume of information and thus are transmitted on a layer obtained in a more stable reception state compared with that of the just-noted information for identifying a broadcast station.

### CITATION LIST

### Patent Literature

[PTL 1] Japanese Laid-Open Patent Publication No. 08-340490

### SUMMARY OF THE INVENTION

### Problems to be Solved by the Invention

In the broadcast receiving apparatus described in the above Patent Literature 1, however, since uniprocessing is the intention, signals that are likely to generate noise are removed and signals having insufficient signal intensity are not used. Therefore, the broadcast receiving apparatus described in the above Patent Literature 1 is not suited to simultaneously performing a plurality of processes.

In addition, in the case where a conventional broadcast receiving apparatus has a plurality of demodulation sections (tuners), between two tuners, one tuner carries out video display and the other tuner carries out signal-reception evaluation. However, a specific algorithm for dividing the demodulation sections in an implementation having three or more tuners is not taken into consideration.

Therefore, the present invention has been made to solve the problems described above, and an object of the present invention is to provide a digital broadcast reception processing apparatus that with a simple algorithm using a plurality of demodulated signals performs a plurality of processes simultaneously, and thus has high functionality yet is inexpensive.

### Solution to the Problems

A digital broadcast reception processing apparatus of the present invention includes: a plurality of antennas configured to receive a plurality of digital broadcast signals; a plurality of demodulation sections configured to demodulate the plurality of received digital broadcast signals and output the plurality of demodulated signals; a demodulation apportioning section configured to divide the plurality of demodulated signals into, and output the divided signals of, Process One unit and Process Two unit; a carrier-combining section configured to combine carriers in the demodulated signals of the Process One unit and outputted from the demodulation apportioning section, and output the carrier-combined demodulated signals; a main processing section configured to process the carrier-combined demodulated signals; a sub-processing section configured to process the demodulated signals of the Process Two unit; and a sub-processing demodulation selecting section configured to decide, and instruct the demodulation apportioning section as to, demodulated signals to be divided into the Process One unit and the Process Two unit. The sub-processing demodulation selecting section obtains the signal intensities of the plurality of demodulated signals, identifies the lowest signal intensity and the highest signal intensity among the plurality of obtained signal intensities, and if the difference between the lowest signal intensity and the highest signal intensity exceeds a predetermined range, selects a demodulated signal other than the demodulated signal of lowest signal intensity as a signal of the Process Two unit.

### Advantageous Effects of the Invention

As described above, according to the present invention, a digital broadcast reception processing apparatus that with a simple algorithm using a plurality of demodulated signals performs a plurality of processes simultaneously, and thus has high functionality yet is inexpensive can be realized.

### BRIEF DESCRIPTION OF THE DRAWINGS

FIG. 1 is a block diagram showing the configuration of a digital broadcast reception processing apparatus according to one embodiment of the present invention.

FIG. 2 is a diagram showing a concept of selection and output of demodulated signals according to the one embodiment of the present invention.

FIG. 3 is a diagram showing a concept of avoiding a signal having the lowest signal intensity according to the one embodiment of the present invention.

FIG. 4 is a flowchart showing an example of an operation of the digital broadcast reception processing apparatus according to the one embodiment of the present invention.

### DESCRIPTION OF EMBODIMENTS

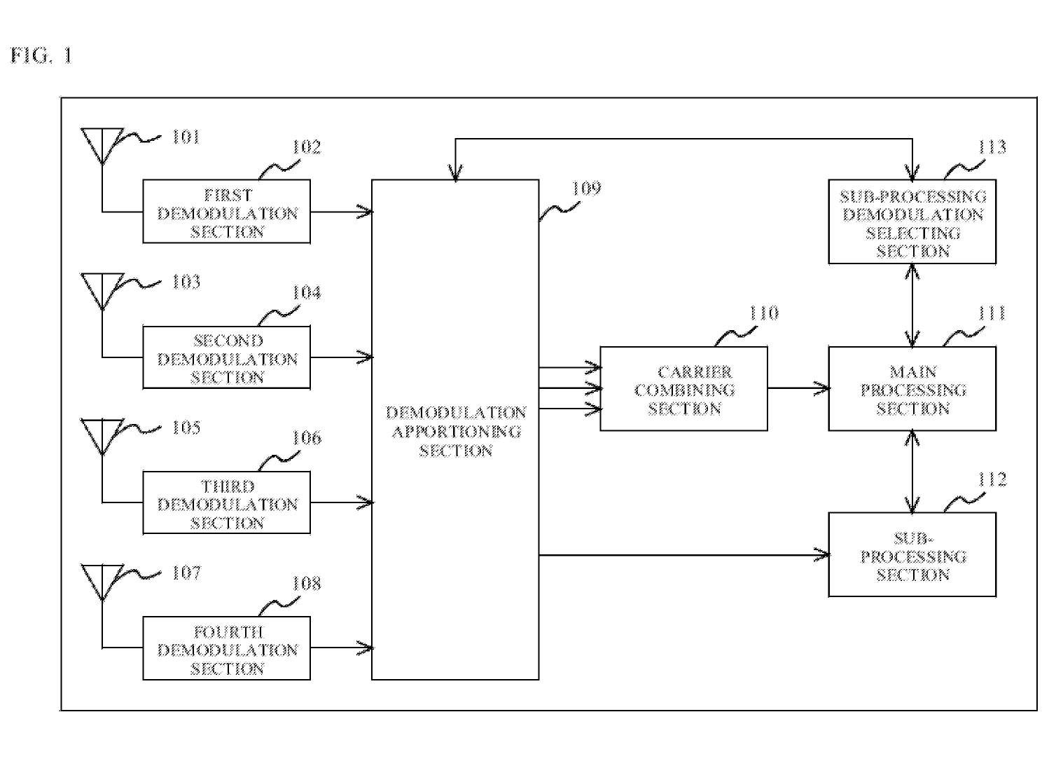

An embodiment of the present invention will be described with reference to FIG. 1. FIG. 1 is a block diagram showing an example of the configuration of a digital broadcast reception processing apparatus according to one embodiment of the present invention. The digital broadcast reception processing apparatus 100 is composed of a first antenna 101, a first demodulation section 102, a second antenna 103, a second demodulation section 104, a third antenna 105, a third demodulation section 106, a fourth antenna 107, a fourth demodulation section 108, a demodulation apportioning section 109, a carrier-combining section 110, a main processing section 111, a sub-processing section 112, and a sub-processing demodulation selecting section 113.

A digital broadcast signal received by the first antenna 101 is determined as a digital broadcast signal and demodulated by the first demodulation section 102, and is outputted as a demodulated signal to the demodulation apportioning section 109. Hereinafter, the same processing is also performed by the second antenna 103 and the second demodulation section 104, by the third antenna 105 and the third demodulation section 106, and by the fourth antenna 107 and the fourth demodulation section 108.

The demodulation apportioning section 109 divides a plurality of demodulated signals into Process One unit and Process Two unit, and outputs the plurality of divided demodulated signals. The signal of the Process One unit indicates signals that will undergo main processing, and the signal of the Process Two unit indicates signals that will undergo sub-processing. Among four demodulated signals, one signal is allocated to the Process Two unit and inputted into the sub-processing section 112, and the other three signals are allocated to the Process One unit and inputted into the carrier-combining section 110.

The carrier-combining section 110 receives the three demodulated signals inputted from the demodulation apportioning section 109 and combines carriers in the three demodulated signals, and outputs the resultant signals as carrier-combined signals to the main processing section 111. The method of the carrier-combining does not depend on the present invention, and thus the description thereof is omitted.

The main processing section 111 processes the carrier-combined signals outputted from the carrier-combining section 110. For example, the main processing section 111 decodes video and sound to provide a state where television viewing is possible, or analyzes a data broadcast or data of program listing, thereby enabling information to be displayed to a user.

The sub-processing section 112 processes the demodulated signal outputted from the demodulation apportioning section 109. For example, the sub-processing section 112 is thought to have various uses such as: processing a One-Seg service to output video on a small screen; and serving to assist in continuous viewing by checking a broadcasting state of another channel and searching for a relay station from which a higher signal intensity seems to be obtained than that of a signal processed currently by the main processing section 111.

The sub-processing demodulation selecting section 113 obtains information on the signal intensity at each of the four demodulation sections from the demodulation apportioning section 109, decides and instructs the demodulation apportioning section 109 to input the demodulated signal from an appropriate demodulation section into the sub-processing section 112. Then, until the processing of the sub-processing section 112 ends, the sub-processing demodulation selecting section 113 maintains the decided dividing state.

The main processing section 111 determines whether the sub-processing is necessary each time a given time period elapses, and issues a sub-processing start notification and a sub-processing end notification to the sub-processing section 112 and the sub-processing demodulation selecting section 113. Here, the sub-processing start notification and the sub-processing end notification may not be issued by the main processing section 111, but may be issued by the sub-processing section 112 or the sub-processing demodulation selecting section 113. For example, the sub-processing demodulation selecting section 113 may determine whether the sub-processing is necessary, on the basis of the signal intensity at each demodulation section, and may issue a sub-processing start notification and a sub-processing end notification to the sub-processing section 112.

It should be noted that the case has been described as an example where four antennas and four demodulation sections are provided in the digital broadcast receiving apparatus described above, but the digital broadcast receiving apparatus may be configured to have two or more antennas and two or more demodulation sections. In addition, the division of the demodulation apportioning section 109 has been described in which three demodulated signals are outputted as the signal of the Process One unit and a single demodulated signal is outputted as the signal of the Process Two unit, but these numbers may be changed depending on the number of the antennas and the number of the demodulation sections. For example, two demodulated signals may be outputted as the signal of the Process One unit and a single demodulated signal may be outputted as the signal of the Process Two unit, or two demodulated signals may be outputted as the signal of the Process One unit and two demodulated signals may be outputted as the signal of the Process Two unit.

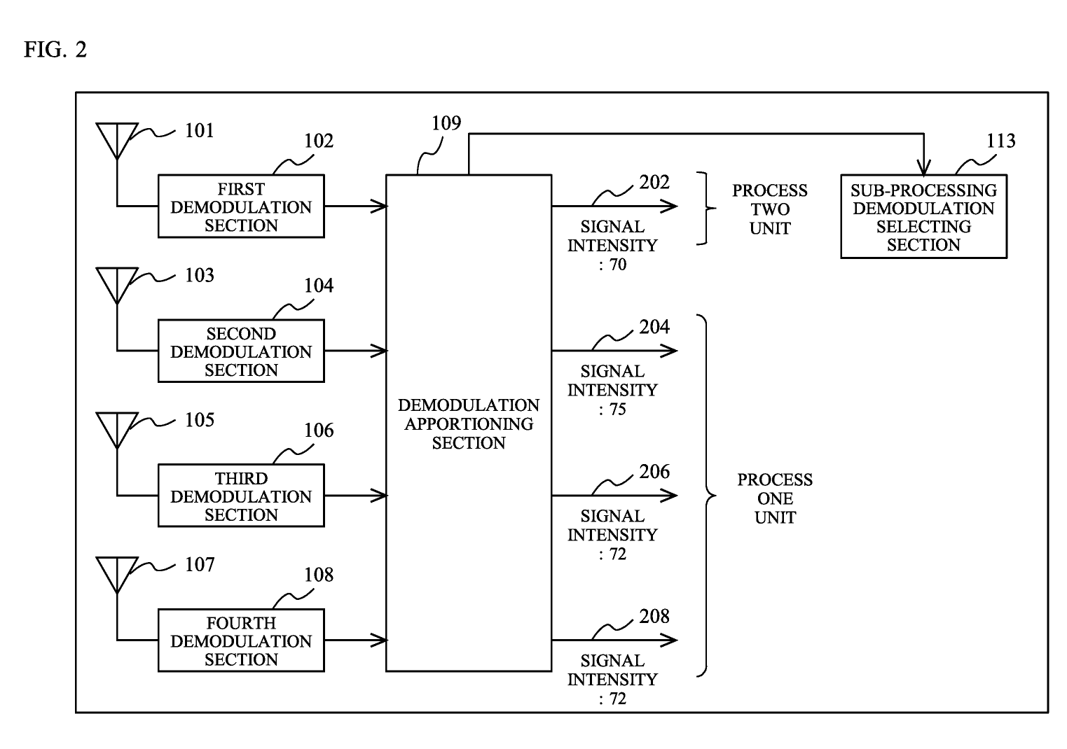

Next, a concept of selection and output of demodulated signals will be described with reference to FIG. 2. With reference to FIG. 2, a description will be given with the antennas (the first antenna 101, the second antenna 103, the third antenna 105, and the fourth antenna 107), the demodulation sections (the first demodulation section 102, the second demodulation section 104, the third demodulation section 106, and the fourth demodulation section 108), the demodulation apportioning section 109, and the sub-processing demodulation selecting section 113 in FIG. 1.

When the first antenna 101, the second antenna 103, the third antenna 105, and the fourth antenna 107 receive digital broadcast signals, the sub-processing demodulation selecting section 113 obtains, from the demodulation apportioning section 109, information on a first signal intensity 202 obtained by the first demodulation section 102, information on a second signal intensity 204 obtained by the second demodulation section 104, information on a third signal intensity 206 obtained by the third demodulation section 106, and information on a fourth signal intensity 208 obtained by the fourth demodulation section 108. Here, the first signal intensity 202 is 70; the second signal intensity 204 is 75; the third signal intensity 206 is 72; and the fourth signal intensity 208 is 72. The sub-processing demodulation selecting section 113 decides that a demodulated signal from the first demodulation section 102 is to be outputted as the signal of the Process Two unit, since the first signal intensity 202 is the lowest among the first signal intensity 202, the second signal intensity 204, the third signal intensity 206, and the fourth signal intensity 208.

It should be noted that the sub-processing demodulation selecting section 113 may not decide that the demodulated signal having the lowest signal intensity is to be outputted as the signal of the Process Two unit and may decide that the demodulated signal having the highest signal intensity (a demodulated signal from the second demodulation section 104 in FIG. 2) is to be outputted as the signal of the Process Two unit. Alternatively, the sub-processing demodulation selecting section 113 may obtain signal intensities at predetermined time intervals and may select the demodulated signal having the lowest signal intensity or the demodulated signal having the highest signal intensity as the signal of the Process Two unit. Still alternatively, the sub-processing demodulation selecting section 113 may select a demodulated signal having a signal intensity other than the above as the signal of the Process Two unit.

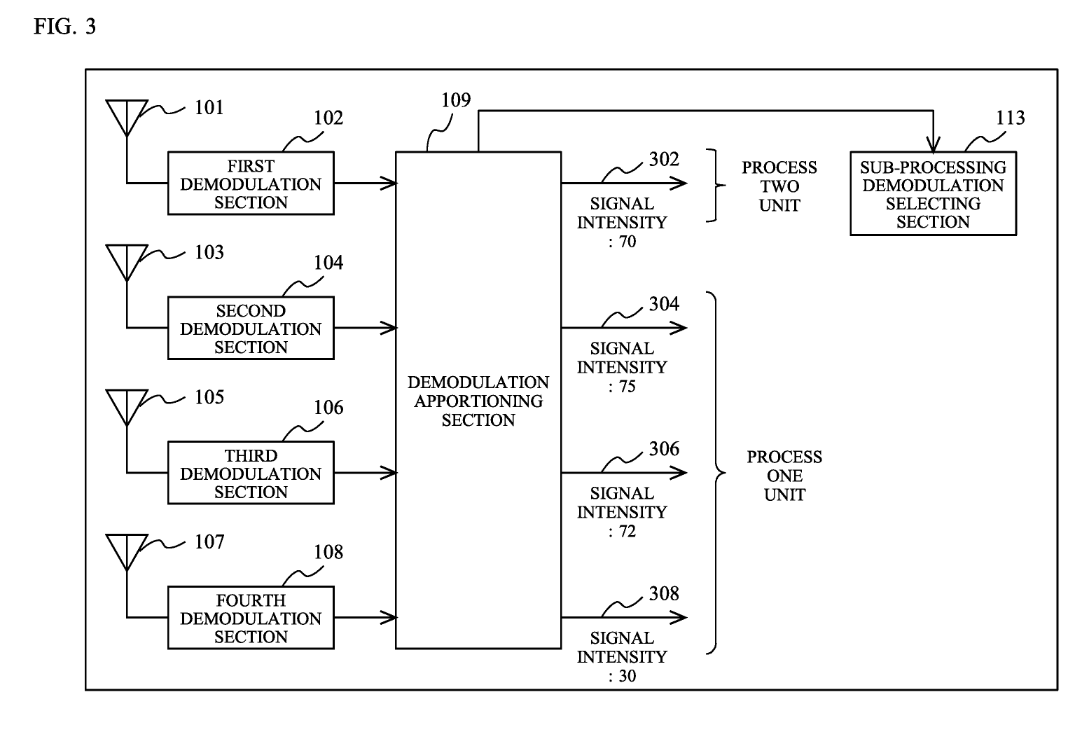

However, if the signal intensity of the demodulated signal having the lowest signal intensity does not meet a predetermined condition, output of this demodulated signal as the signal of the Process Two unit is avoided and a demodulated signal having another signal intensity is outputted as the signal of the Process Two unit. FIG. 3 is a diagram showing a concept that the digital broadcast reception processing apparatus according to the present embodiment avoids output of a demodulated signal having the lowest signal intensity as the signal of the Process Two unit. With reference to FIG. 3, a description will be given with the antenna (the first antenna 101, the second antenna 103, the third antenna 105, and the fourth antenna 107), the demodulation sections (the first demodulation section 102, the second demodulation section 104, the third demodulation section 106, and the fourth demodulation section 108), the demodulation apportioning section 109, and the sub-processing demodulation selecting section 113 in FIG. 1.

When the first antenna 101, the second antenna 103, the third antenna 105, and the fourth antenna 107 receive digital broadcast signals, the sub-processing demodulation selecting section 113 obtains, from the demodulation apportioning section 109, information on a first signal intensity 302 obtained by the first demodulation section 102, information on a second signal intensity 304 obtained by the second demodulation section 104, information on a third signal intensity 306 obtained by the third demodulation section 106, and information on a fourth signal intensity 308 obtained by the fourth demodulation section 108.

Here, the first signal intensity 302 is 70; the second signal intensity 304 is 75; the third signal intensity 306 is 72; and the fourth signal intensity 308 is 30. Among the first signal intensity 302, the second signal intensity 304, the third signal intensity 306, and the fourth signal intensity 308, the fourth signal intensity 308 is the lowest but is lower than 50% that of the second signal intensity 304 which is the highest. The sub-processing demodulation selecting section 113 therefore determines that, with there being a possibility of breakdown or disconnection, there is a high probability that the fourth signal will not be able to withstand the sub-processing of the fourth demodulation section 108, which obtains the fourth signal intensity 308. Thus, the sub-processing demodulation selecting section 113 decides that a demodulated signal from the first demodulation section 102 that obtains the first signal intensity 302, which is the second-lowest, is to be outputted as the signal of the Process Two unit. In other words, when obtaining a plurality of signal intensities, the sub-processing demodulation selecting section 113 compares the lowest signal intensity to the highest signal intensity and determines whether to output a demodulated signal having the lowest signal intensity as the signal of the Process Two unit on the basis of whether the difference between the lowest signal intensity and the highest signal intensity exceeds a predetermined range.

It should be noted that in the example described above, the sub-processing demodulation selecting section 113 determines whether to output the demodulated signal having the lowest signal intensity as the signal of the Process Two unit on the basis of whether the lowest signal intensity is equal to or less than 50% that of the highest signal intensity, but may appropriately set a range for determining the signal intensity, in accordance with a situation in which the digital broadcast reception processing apparatus 100 is used. In addition, in the example described above, when it is determined that the demodulated signal having the lowest signal intensity is not suitable as the signal of the Process Two unit, the demodulated signal having the second-lowest signal intensity is outputted as the signal of the Process Two unit, but instead, the demodulated signal having the second-highest signal intensity (i.e., a demodulated signal from the third demodulation section 106) or the demodulated signal having the highest signal intensity (i.e., a demodulated signal from the first demodulation section 102) may be decided to be outputted as the signal of the Process Two unit.

In other words, when obtaining the signal intensities of a plurality of demodulated signals, the sub-processing demodulation selecting section 113 identifies the lowest signal intensity and the highest signal intensity. If the difference between the lowest signal intensity and the highest signal intensity exceeds the predetermined range, the sub-processing demodulation selecting section 113 outputs a demodulated signal other than the demodulated signal having the lowest signal intensity as the signal of the Process Two unit. In addition, if the difference between the lowest signal intensity and the highest signal intensity does not exceed the predetermined range, the sub-processing demodulation selecting section 113 outputs the demodulated signal having the lowest signal intensity (as described above, it may be a demodulated signal other than the demodulated signal having the lowest signal intensity) as the signal of the Process Two unit.

It should be noted that the sub-processing demodulation selecting section 113 preferably outputs the demodulated signal having the highest signal intensity as the signal of the Process One unit. This is because it is thought that the demodulated signal having the highest signal intensity allows video and sound to be stably provided to the user and should be used for the main processing.

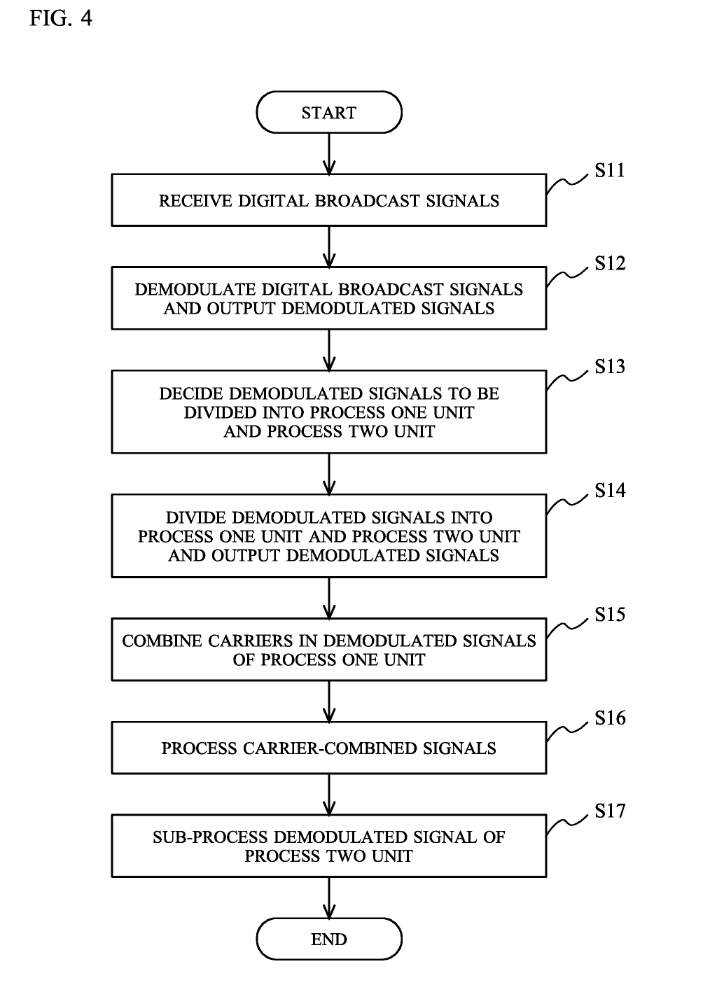

FIG. 4 is a flowchart showing an example of an operation of the digital broadcast reception processing apparatus. In FIG. 4, a plurality of the demodulation sections 102, 104, 106, and 108 receive digital broadcast signals via a plurality of antennas 101, 103, 105, and 107 (step S11). A plurality of the demodulation sections 102, 104, 106, and 108 demodulate a plurality of the received digital broadcast signals and output a plurality of demodulated signals (step S12). The sub-processing demodulation selecting section 113 decides demodulated signals to be divided into the Process One unit and the Process Two unit (step S13). Typically, the sub-processing demodulation selecting section 113 obtains the signal intensities of the plurality of demodulated signals and identifies the lowest signal intensity and the highest signal intensity among a plurality of the obtained signal intensities. If the difference between the lowest signal intensity and the highest signal intensity exceeds the predetermined range, the sub-processing demodulation selecting section 113 allocates the demodulated signals other than the demodulated signal having the lowest signal intensity into the Process Two unit.

In accordance with the decision of the sub-processing demodulation selecting section 113, the demodulation apportioning section 109 divides the plurality of demodulated signals into the Process One unit and the Process Two unit and outputs the plurality of demodulated signals (step S14). The carrier-combining section 110 combines carriers in the demodulated signals of the Process One unit and outputs the resultant signals as carrier-combined signals (step S15). The main processing section 111 processes the carrier-combined signal outputted from the carrier-combining section 110 (step S16). The sub-processing section 112 processes the demodulated signal of the Process Two unit (step S17).

In addition, the processing procedure executed by the digital broadcast reception processing apparatus described above may be realized by a CPU interpreting and executing determined program data that is stored in a storage device (ROM, RAM, hard disk, or the like) and allows the above-described processing procedure to be executed. In this case, the program data may be introduced into the storage device via a storage medium, or may be executed directly on the storage medium. Here, the storage medium refers to a semiconductor memory such as a ROM, a RAM, and a flash memory; a magnetic disk memory such as a flexible disk and a hard disk; an optical disk memory such as a CD-ROM, a DVD, and a BD; and a memory card etc. Further, the storage medium has a concept including a communication medium such as a telephone line, a transmission path, and the like.

### INDUSTRIAL APPLICABILITY

The present invention is useful for a diversity-reception-type digital broadcast reception processing apparatus for mobile reception and the like.

### DESCRIPTION OF THE REFERENCE CHARACTERS

100 digital broadcast reception processing apparatus

101 first antenna

102 first demodulation section

103 second antenna

104 second demodulation section

105 third antenna

106 third demodulation section

107 fourth antenna

108 fourth demodulation section

109 demodulation apportioning section

110 carrier-combining section

111 main processing section

112 sub-processing section

113 sub-processing demodulation selecting section

1. A digital broadcast reception processing apparatus comprising:
a plurality of antennas configured to receive a plurality of digital broadcast signals;
a plurality of demodulation sections configured to demodulate the plurality of received digital broadcast signals and output the plurality of demodulated signals;
a demodulation apportioning section configured to divide the plurality of demodulated signals into, and output the divided signals of, Process One unit and Process Two unit;
a carrier-combining section configured to combine carriers in the demodulated signals of the Process One unit, and output the carrier-combined demodulated signals;
a main processing section configured to process the carrier-combined demodulated signals;
a sub-processing section configured to process the demodulated signals of the Process Two unit; and
a sub-processing demodulation selecting section configured to decide, and instruct the demodulation apportioning section as to, demodulated signals to be divided into the Process One unit and the Process Two unit; wherein
the sub-processing demodulation selecting section obtains the signal intensities of the plurality of demodulated signals, identifies the lowest signal intensity and the highest signal intensity among the plurality of obtained signal intensities, and if the difference between the lowest signal intensity and the highest signal intensity exceeds a predetermined range, decides that a demodulated signal other than the demodulated signal having lowest signal intensity is to be allocated to the Process Two unit.

2. The digital broadcast reception processing apparatus according to claim 1, wherein the sub-processing demodulation selecting section obtains the signal intensities of the plurality of demodulated signals at predetermined time intervals.

3. The digital broadcast reception processing apparatus according to claim 1, wherein the sub-processing demodulation selecting section decides that a demodulated signal having lowest signal intensity is to be allocated to the Process Two unit if the difference between the lowest signal intensity and the a highest signal intensity does not exceed the predetermined range.

4. The digital broadcast reception processing apparatus according to claim 1, wherein the sub-processing demodulation selecting section decides that at least the demodulated signal having the highest signal intensity among the plurality of demodulated signals is to be allocated to the Process One unit.

5. The digital broadcast reception processing apparatus according to claim 1, wherein the sub-processing demodulation selecting section decides that a demodulated signal having the second-lowest signal intensity is to be allocated to the Process Two unit if the difference between the lowest signal intensity and the highest signal intensity exceeds the predetermined range.

6. The digital broadcast reception processing apparatus according to claim 1, wherein the sub-processing demodulation selecting section decides that a demodulated signal having the second-highest signal intensity is to be allocated to the Process Two unit if the difference between the lowest signal intensity and the highest signal intensity exceeds the predetermined range.

7. A method for implementation by a digital broadcast reception processing apparatus furnished with a plurality of antennas, the method comprising:
a step of receiving a plurality of digital broadcast signals through the plurality of antennas;
a demodulation step of demodulating the plurality of digital broadcast signals and outputting the plurality of demodulated signals;
a sub-processing demodulation selecting step of deciding demodulated signals to be divided into Process One unit and Process Two unit;
a demodulation apportioning step of dividing the plurality of demodulated signals into, and outputting the divided signals of, the Process One unit and the Process Two unit;
a carrier-combining step of combining carriers in the demodulated signals of the Process One unit, and outputting the carrier-combined demodulated signals;
a main processing step of processing the carrier-combined demodulated signals; and
a sub-processing step of processing the demodulated signals of the Process Two unit; wherein
the sub-processing demodulation selecting step obtains the signal intensities of the plurality of demodulated signals, identifies the lowest signal intensity and the highest signal intensity among the plurality of obtained signal intensities, and if the difference between the lowest signal intensity and the highest signal intensity exceeds a predetermined range, decides that a demodulated signal other than the demodulated signal having lowest signal intensity is to be allocated to the Process Two unit.
